(19) United States
(12) Patent Application Publication
(10) Pub. No.: US 2022/0319743 A1
(43) Pub. Date: Oct. 6, 2022

(54) APPARATUS FOR UNRAVELLING WIRE ROPES

(71) Applicant: ZECK GMBH, Schesslitz (DE)

(72) Inventor: Franz RIESER, Bad Hofgastein (AT)

(73) Assignee: ZECK GMBH, Schesslitz (DE)

(21) Appl. No.: 17/763,702

(22) PCT Filed: Sep. 25, 2020
(86) PCT No.: PCT/AT2020/060346

§ 371 Date: Mar. 25, 2022

(30) Foreign Application Priority Data
Sep. 26, 2019 (AT) A 50820/2019

(51) Int. Cl. H01B 15/00; H02G 1/12

(52) U.S. Cl. CPC H01B 15/006; H02G 1/126; H02G 1/02

(57) ABSTRACT

The invention relates to an apparatus for unravel-ling wire ropes (3), which are made up of a complex of different materials, having a peeling device (1) with an opening (5), through which a core (9) of the wire rope (3) passes along a through-feed axis (D) and a through-feed direction (Z), while an outer portion (10) is separated, said peeling device (1) comprising a mandrel (4) through which the opening (5) passes axially, with at least one rotatable cutting wheel (12) being provided next to the mandrel (4), which wheel has on the circumference thereof at least one blade (13) and the axis of rotation (R) of which wheel is substantially transverse to the through-feed axis (D), characterized in that a cut-ting profile (6) of the blade (13) or a common cutting profile (6) of the blades (13) is concave in form.

The invention relates to a device for deconstructing wire cables made of a combination of different materials, comprising a peeling mechanism having an opening, through which an inner portion of the wire cable runs along a pass-through axis and a pass-through direction, while at least part of an outer portion is cut off, said peeling mechanism having a mandrel, through which the opening extends axially, wherein provided next to the mandrel is at least one rotatable cutting wheel, which has at least one blade on its circumference and the axis of rotation of which is substantially transverse to the pass-through axis.

It also relates to a method for deconstructing wire cables, in which a wire cable is conducted through a peeling mechanism having a mandrel, wherein an inner portion is conducted through an opening along a pass-through axis in the mandrel and at least part of an outer portion is peeled away by an outer surface of the mandrel.

Such devices are particularly useful if the individual materials of the wire cable are to be reused or recycled. This is often a wire cable or cable having a core as the inner portion and a plurality of individual wires, particularly preferably made of aluminium, arranged preferably helically therearound as the outer portion. The core may be made of steel and may consist of strands or else may be a single wire. By way of example, conductor cables for high-voltage lines are such wire cables, that is to say cables which are used to transport power, for example of overhead lines.

AT 505 038 A1 describes a deconstructing device, in which the blade of a cutting wheel is arranged with an axis of rotation parallel to the pass-through axis. Said device enables the outer portion to be cut into pieces very easily. However, the pass-through speed of the wire cable is limited since otherwise jamming very often occurs with the cutting wheel or poorly cut pieces of the outer portion. This leads to a long processing time for long wire cables. In addition, the portions are quite long, which leads to a very large volume of the resulting pieces. This makes the pieces of the outer portion more difficult to handle and transport. In addition, the inner portions thus exposed cannot easily be wound up on a coiling mechanism and often become dirty.

EP 0 105 668 A2 describes an embodiment using a cutting wheel which has an axis of rotation transverse to the pass-through axis. Somewhat higher throughput speeds of the wire cable can thus be achieved. Said embodiment has only one saw since, due to the helical arrangement of the outer wires, any wire cable will be cut after a particular length. However, the cutting wheel may still become jammed with parts of the outer portion which have not yet been cut off but which have already been pushed away by the mandrel. This limits the throughput speed and thus the maximum length of cable processed per unit time.

The aim of the invention is therefore to avoid the described disadvantages and to provide a device of the aforementioned type which exhibits increased productivity.

This aim is achieved according to the invention in that a cutting profile of the blade or a joint cutting profile of the blades is of concave shape.

It is also achieved in that an outer portion is cut off over an outer surface of the mandrel by at least one blade of at least one cutting wheel having an axis of rotation transverse to the pass-through axis, which blade forms a concave cutting profile.

Due to the concave cutting profile, the blade cuts off or the blades cut off a relatively large part of the outer portion during one revolution. In the case of a strand arrangement, therefore, more individual wires of the outer portions can be cut off. Thus, on the one hand, the portions cut off are shorter and, on the other hand, in particular also those parts of the outer portion that are located in the region of the cutting wheel are cut off. This reduces the risk of jamming between the cutting wheel and parts of the outer portion. This enables an increased throughput speed and thus increased productivity per unit time. In addition, the device according to the invention has an extremely simple structure and is inexpensive to manufacture.

Preferably, the device has a feeding mechanism for feeding the wires to be deconstructed. Here, a feeding mechanism means a mechanism which suitably conducts the wire cable towards the peeling mechanism; by way of example, this may be a roller or a pair of rollers.

While the cutting wheel rotates, a cutting profile defined by the blade or blades is created, which along the thickness of the cutting wheel is composed of the edge points of the cutting edges of the blades that are furthest away from the axis of rotation. During the rotation, the blades move past an outer surface of the mandrel. Here, the cutting profile means the profile formed transverse to the outer surface. In the simplest case, one blade or a plurality of blades having the same cutting edge are arranged. The cutting profile is then formed by the profile of the one cutting edge, or the joint cutting profile corresponds to the identical profiles of each cutting edge. If blades having differently shaped or differently arranged cutting edges are provided, then the rotation of the cutting wheel leads to the formation of a joint cutting profile composed of parts of the cutting edges.

Here, concave cutting profiles will be understood to mean not only kink-free, curved cutting profiles, but also those cutting profiles that have kinks and/or edges. A concave cutting profile means a concave profile starting from the axis of rotation of the cutting wheel, that is to say a profile in which, as seen from the axis of rotation, any connecting path between two points of the cutting profile lies outside of the cutting profile. Relatively small bulges or protrusions do not cause any inconvenience; what is important is that the cutting profile is substantially concave and thus forms a recess, in which the inner portion can be at least partially arranged.

In addition to the blade or blades, other tools may also be arranged on the cutting wheel, for example bending elements for bending the outer regions to be cut off.

It is particularly advantageous if an individual blade has a concave cutting profile. In other words, a blade has a cutting edge of concave shape. One individual blade on the cutting wheel is thus sufficient to produce a concave cutting profile during a revolution and thus to expose the inner portion. Alternatively, it may also be advantageous if a plurality of blades form a joint cutting profile which is substantially concave.

In this sense, it is also advantageous if the cutting profile is U-shaped or V-shaped. A simple shape that is easy to manufacture is thus found, which can be achieved using only one blade or only a few blades. It is therefore particularly advantageous if at least one blade has a cutting edge with a base portion which is substantially parallel to the axis of rotation of its cutting wheel, and that the cutting edge has at least one side portion which is at an angle to the axis of rotation of its cutting wheel.

In one preferred embodiment, it is provided that at least one side portion is arranged on each side of the base portion. The inner portion is thus surrounded on both sides, and a particularly large part of the outer portion can be removed.

It is also particularly advantageous if the cutting profile partially surrounds the inner portion during operation of the device.

To avoid any imbalance even at high speeds and to achieve outer portions of identical size, it may be provided that the peeling mechanism has a plurality of cutting wheels which are arranged evenly around the pass-through axis.

To enable the parts of the outer portion to be cut off easily and cleanly, it may be provided that the blade or the blades, during operation of the device, describe a path which passes an outer surface of the mandrel at a small gap therefrom. In this case, it is particularly advantageous if the gap is smaller than 2 mm and preferably is smaller than the diameter of the individual wires of the outer portion.

To enable even sliding of the outer portion on the mandrel and to achieve good separation, it may be provided that the mandrel has an outer surface with a frustoconical portion and preferably an adjoining cylindrical portion.

It may also be provided that the mandrel has, at least in the transition region from the frustoconical portion to the cylindrical portion, an annular element which is preferably made of steel.

In addition, it may be advantageous if the cutting wheel is arranged at the cylindrical portion and the gap presents itself between the path of the blades and the transition region from the frustoconical portion to the cylindrical portion.

To obtain even shorter pieces of the outer portion, it is advantageous if the peeling mechanism has two cutting wheels which are arranged opposite one another around the pass-through axis, and that the cutting profiles substantially encircle a cross-section of the outer surface of the mandrel. The inner portion is thus freed from the outer portion as fully as possible, with the outer portion being cut off on all sides. Depending on the position of the cutting wheel, it may be advantageous if the cutting profiles substantially encircle a cross-section of the outer surface of the mandrel, namely if the cutting wheels are arranged such that the cutting profiles cut the outer portions in the region of the outer surface of the mandrel.

In order for the wire cable to be fed and made available to the peeling mechanism, it may be provided that the device has a pulling mechanism for exerting a pulling force on the wire cable, preferably on the inner portion of the wire cable that has passed through the opening of the peeling mechanism. Accordingly, it may also be provided that the inner portion is pulled through the mandrel by a pulling mechanism downstream of the mandrel.

It may also be provided that the pulling mechanism is arranged upstream of the mandrel. This may be advantageous particularly in embodiments which are used directly while removing a wire cable, for example from a high-voltage mast or an overhead line mast. Accordingly, it may be advantageous if the wire cable is moved by a pulling mechanism upstream of the mandrel.

The pulling mechanism may be driven hydraulically or alternatively also electrically. The peeling mechanism is preferably electrically operated, but may also be of hydraulic design. The pulling mechanism preferably achieves a throughput speed of at least 3 km/h, particularly preferably at least 4 km/h.

In order that the throughput speed of the wire cable can be adjusted, it is advantageous if an adjusting mechanism for controlling and adjusting the speed of the pulling mechanism is connected to the pulling mechanism. Accordingly, it is also advantageous if the pulling speed of the pulling mechanism is controllable.

Wire cables having outer portions consisting of one to three layers can be particularly easily peeled using a peeling mechanism. If a plurality of layers are arranged on the inner portion, the power of the peeling machine may no longer be sufficient. Particularly in such a case, it may be advantageous if the device has at least two peeling mechanisms which are arranged in series one behind the other along the wire cable, and that a first, upstream peeling mechanism has a larger opening than a second, downstream peeling mechanism. In other words, the peeling mechanisms are arranged one behind the other, preferably along the pass-through direction Z. Accordingly, it may also be advantageous if firstly an outer part of the outer portion is peeled away by a first peeling mechanism and then an inner part of the outer portion is peeled away by a second peeling mechanism.

In order to achieve particularly easy further processing of the parts of the outer portions, it may be provided that the cut-off parts of the outer portion are cut to an average length which is smaller than 70 mm and which is preferably smaller than 60 mm.

It is particularly advantageous if the cutting wheel is driven at a speed which is greater than 500 min⁻¹ and which is preferably greater than 550 min⁻¹, particularly preferably around 600 min⁻¹. This prevents the production of excessively long parts of the outer portion, and in addition reduces the risk of snagging or jamming of the cutting wheel.

In addition, the risk of jamming is further reduced if it is provided that all the cutting wheels in the region of the wire cable rotate in the direction of a pass-through direction of the inner portion.

It is advantageous if the device has at least one collecting container for the cut-off parts of the outer portion. To this end, the mandrel may is arranged for example in a tub for receiving the parts of the outer portion. By way of example, the collecting container may be a big bag, a container, or another suitable storage shell.

In addition, it may be provided that the device has, downstream of the mandrel, at least one coiling mechanism for winding up the inner portion. The exposed inner portion is thus made available in a space-saving manner for reuse or recycling. Accordingly, it may also be advantageous if the inner portion of the wire cable is wound up on a coiling mechanism downstream of the mandrel.

The coiling mechanism usually comprises at least one reel, onto which the inner portion is wound. The coiling mechanism may also exert a pulling force on the inner portion in order to achieve tight coiling. To this end, the coiling mechanism may be motorized, or may be hydraulically operated. The coiling mechanism may in this case take over the task of the pulling mechanism or may exert force on the wire cable in addition to the pulling mechanism, wherein in the latter case the pulling force of the coiling mechanism is lower than the pulling force of the pulling mechanism.

For particularly fast and efficient processing of a wire cable or wire cable part that is no longer in use, a method for maintaining or removing a power line, in particular a high-voltage line, is advantageous, wherein a wire cable or part of a wire cable is released from its anchorages, for example anchorages to an overhead line mast, is pulled off, is deconstructed by a method as described, and the inner portion is then rolled up on a coiling mechanism. The procedure is thus very quick and easy, and the different materials can immediately be separated.

Released from the anchorages means that the wire cable or the wire cable part is made pullable at least along its longitudinal extension. This therefore also includes the mere loosening of the anchorages, as a result of which the pulling mechanism can then pull the wire cable or the wire cable part out of the anchorages. Alternatively, rollers may also be provided in the regions of the anchorages, on which rollers the wire cable or the wire cable part is arranged such as to be movable along the longitudinal extension.

The pulling mechanism and/or the coiling mechanism may be embodied jointly with the peeling mechanism, for example in a common housing, or may also exist as separate modules, wherein the modules may be connected to one another for control and/or force transmission purposes. In one preferred embodiment, the pulling mechanism, the peeling mechanism and the coiling mechanism are separate parts, wherein, for operation, the peeling mechanism is arranged along the wire cable between the pulling mechanism and the coiling mechanism. The pulling mechanism pulls the wire cable with great force, for example from overhead line masts, and makes it available to the peeling mechanism. The inner portion freed from the outer portion is rolled up at the coiling mechanism downstream of the peeling mechanism.

It is particularly advantageous if it is provided that the pulling-off and the method for deconstructing the wire cable or part of the wire cable and rolling it up on the coiling mechanism is carried out in one operation. The method for deconstructing the wire cable or part of the wire cable and rolling it up on the coiling mechanism can thus be carried out directly after the wire cable or part of the wire cable has been released from its anchorages. There is thus no longer any need to roll up the as yet unseparated wire cable, transport it, and then separate it, and this leads to easier logistics and increased efficiency.

It is particularly advantageous if the wire cable or part of the wire cable is made movable from the anchorages of an overhead line mast and is stored in the region of the anchorages, preferably on rolls, and is pulled off. Particularly in the case of high-voltage lines and other lines which are attached to overhead line masts at great height, processing can thus take place with as little effort as possible and without using the ground below the masts. There is no longer any need for the wire cable or the wire cable part to be dropped from the overhead line mast, but rather it is simply pulled along the masts.

In this sense, it is very particularly advantageous if a new wire cable is attached to the side of the wire cable or part of the wire cable that is remote from the peeling mechanism, before the wire cable is pulled off, preferably by a pulling mechanism. Simultaneously, therefore, the new wire cable is brought into position and the wire cable to be removed is prevented from sliding to the ground between the overhead line masts.

The terms upstream or downstream always refer to directions or positions relative to the pass-through direction, that is to say along the movement direction in which the wire cable is moved.

The present invention will be explained in greater detail below on the basis of the non-limiting embodiment variants shown in the figures, in which:

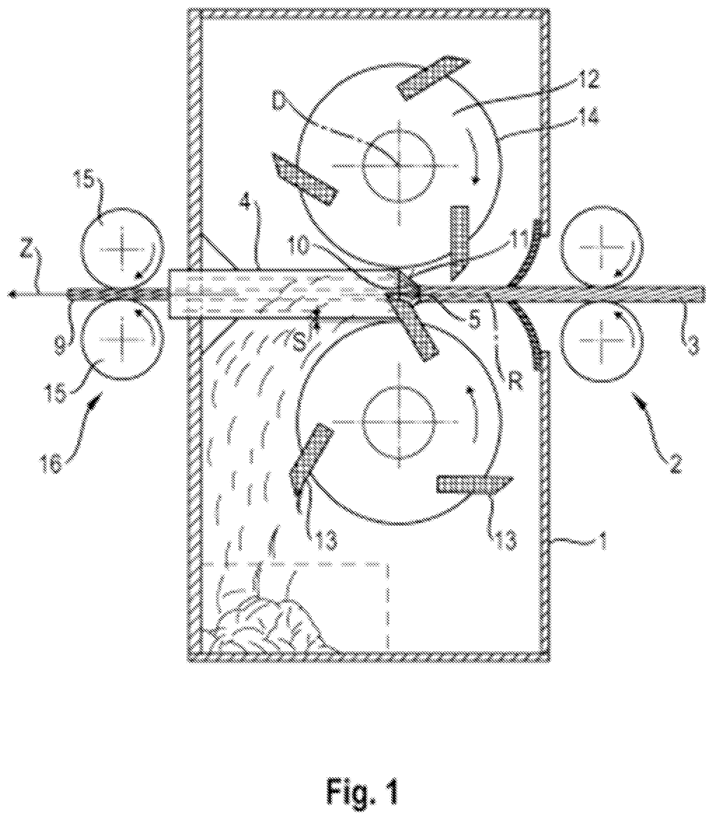

FIG. 1 shows a device according to the invention in a first embodiment in a schematic sectional view;

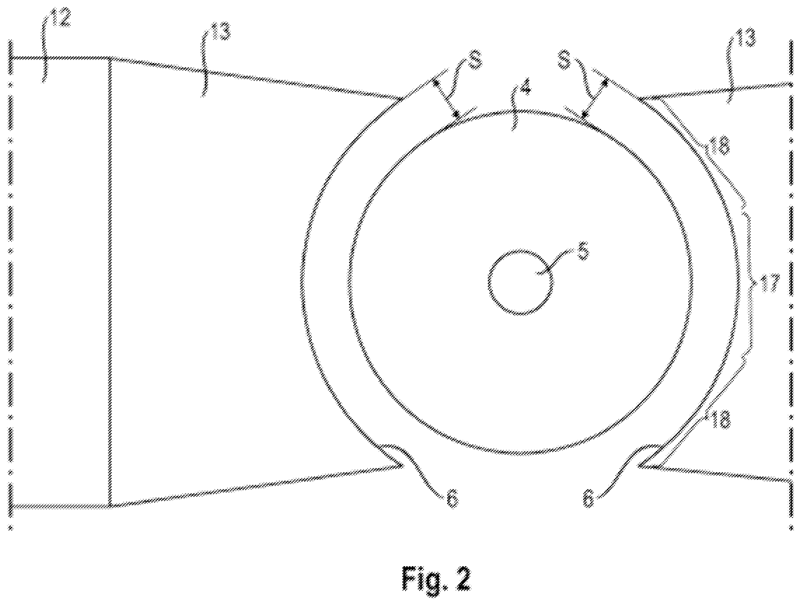

FIG. 2 shows a detail view of the mandrel with part of a cutting wheel in a sectional view normal to the outer surface of the mandrel;

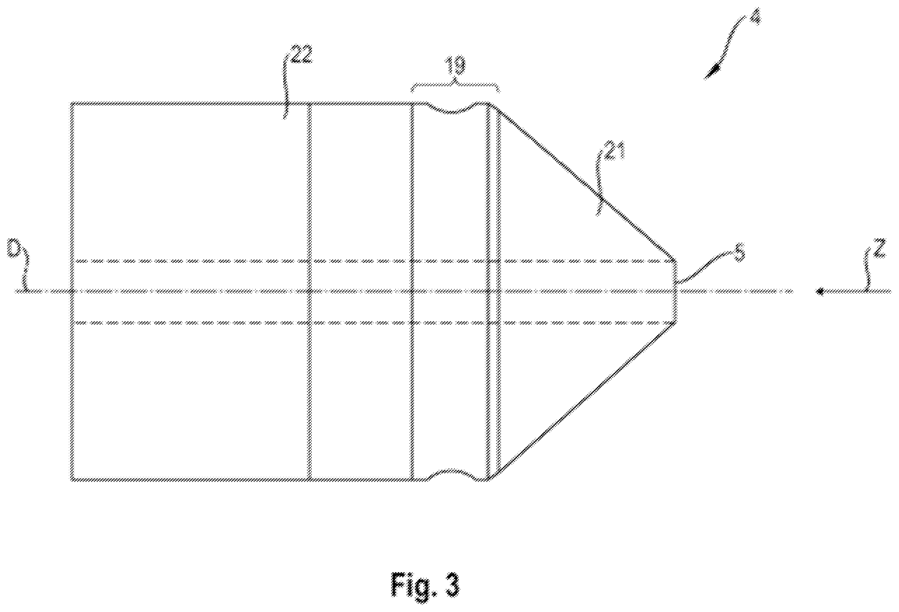

FIG. 3 shows a side view of the mandrel;

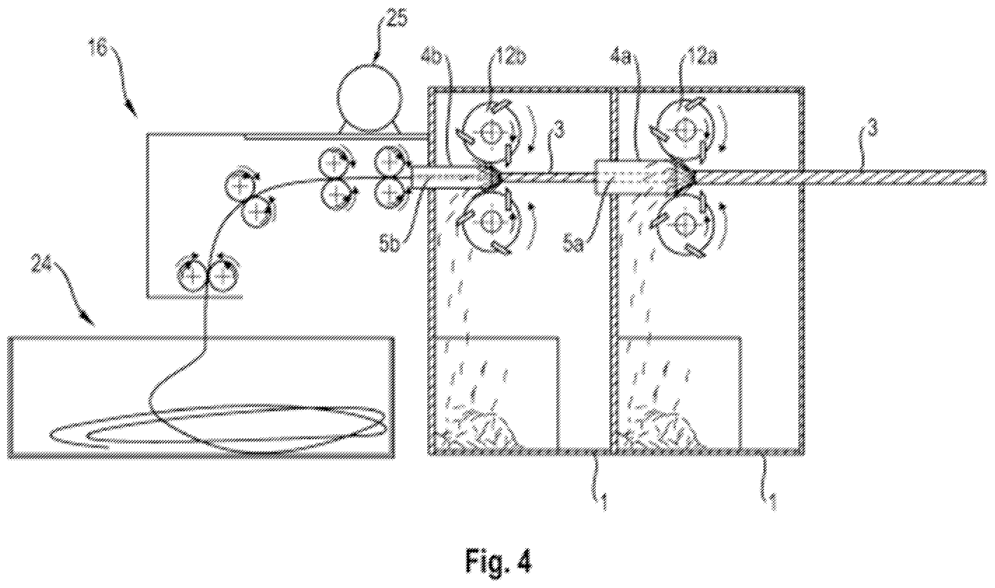

FIG. 4 shows an alternative embodiment in a schematic sectional view.

FIG. 1 shows an embodiment of the invention which has a mandrel 4, through which a wire cable 3 is conducted. The device has a peeling mechanism 1 with a housing, to which the wire cable 3 is fed via two feed rollers of a feeding mechanism 2 through an opening concealed by rubber flaps. The mandrel 4 is arranged within or above the tub 1, said mandrel having an opening 5 which extends in the axial direction. Wheels 15 and a coiling mechanism (not shown) are arranged downstream of the tub 1, with the exposed inner portion being rolled up on a coiling block of the coiling mechanism.

The wire cable 3 consists of an inner portion 9 and an outer portion 10, which coaxially encircles the inner portion 9. The opening 5 of the mandrel 4 is designed such that it is suitable for receiving the inner portion 9 with play, so that only the inner portion 9 passes through the mandrel 4 along a pass-through axis D and ultimately is wound up on a coiling block of a coiling mechanism. In contrast, the outer portion 10 of the wire cable 3 is peeled away at the outer surface 11 of the mandrel 4, which tapers conically towards the front, whereby a certain degree of splitting into individual wires takes place. After the conical, frustoconical portion of the outer surface 11, said outer surface has in the downstream direction a substantially cylindrical portion, wherein the frustoconical portion merges into the cylindrical portion via an edge. Two driven cutting wheels 12, which are rotatable about axes of rotation R, are arranged immediately adjacent to the mandrel 4, said cutting wheels being provided with a plurality of blades 13 at their outer circumference. Each cutting wheel 12 has a cylindrical outer surface 14. During the rotation of the cutting wheels, a radially outermost surface of the cutting wheel 12 is defined by the cutting edges of the blades, said outermost surface defining in section a cutting profile 6. The gap S between the cutting profile 6, defined by the blades 13, and the edge between the portions of the outer surface 11 of the mandrel 4 is very small and is for example 0.8 mm. A total of three blades 13 per cutting wheel 12 are arranged radially evenly on the outer surface 14. The cutting wheels 12 are arranged at the same height as the mandrel 4, wherein it may be provided that they are arranged offset to one another.

Two motorized wheels 15 of a hydraulic pulling mechanism 16 are arranged downstream of the mandrel 4 and outside of the tub 1, said wheels clamping the exposed inner portion and pulling it along a pulling direction Z. Each cutting wheel 12 is assigned a motor that drives it, the speed preferably being kept substantially constant during operation. During operation, the cutting wheels 12 rotate in opposite directions and such that the parts of the cylindrical outer surface 14 facing towards the wire cable 3 rotate in the pulling direction Z. The cutting wheels 12 thus rotate in the same direction as the wheels 15 located in each case on the same side of the wire cable 3.

The rotational impulse exerted on the wire cable 3 by the cutting wheel as the latter rotates at speeds of about 600 min⁻¹ ensures that the outer portion is cut through completely.

The present invention makes it possible to provide a device of simple structure which ensures that high-quality recyclable materials are recovered.

FIG. 2 shows a detail of the embodiment of FIG. 1, wherein in each case one blade 13 of each cutting wheel 12 is shown at the mandrel 4. Here, the cut is made at the point on the pass-through axis D at which the blades 13 come closest to the mandrel 4 as they rotate. In this embodiment, this is the transition region between the frustoconical region and the cylindrical region. In this embodiment, this is at the cylindrical portion of the outer surface 11, as a result of which said cut is normal to the pass-through axis D. If the blades 13 come closest to the outer surface in the conical region, two cuts would be necessary for the two cutting wheels 13, each of said cuts being normal to the outer surfaces 11 in the region of the cutting wheels 13. It can be seen here that the gaps S between the outer wall 11 of the mandrel 4 and the blades 13 is very small. Each blade 13 has a cutting edge which defines a cutting profile 6 that is of concave shape, is U-shaped, and thus is substantially adapted to the shape of the outer wall of the mandrel 4. As the blade rotates past the mandrel, a large part of the outer portion 10 moving over the outer surface 11 is cut off by the blade 13. The blades 13 thus encircle at least three-quarters of the circumference of the mandrel 4. Each cutting profile 6 has a base portion 17 and a side portion 18 on each side of the base portion 17, wherein in this embodiment the base portion 17 merges directly into the side portions 18. Alternatively, edges or pronounced changes in slope may be provided in the transition region between the portions 17, 18.

It is advantageous if the cutting profile 6 corresponds to the contour of the outer surface 11 of the mandrel 4. A particularly large part of the outer portion 10 can thus be cut away.

The structure of the mandrel 4 can be seen in FIG. 3. In the region of the edge on the cylindrical part, the mandrel 4 has an annular element 19 which serves as a reinforcing element and is made of steel. Here, the annular element forms the last part of the frustoconical region, the transition region, and also part of the cylindrical region. During the rotation, the peeled-away parts of the outer portion 10 are pressed against the edge and the annular element 19 by the blades 13 and are cut off. This part of the mandrel 4 is thus subjected to considerable mechanical stress. The annular element 19 can be re-sharpened as required in order to enable a clean cut. Provided in the cylindrical part of the annular element 19 is an indentation 20 which can serve as an indication of the extent to which the annular element can be further sharpened.

FIG. 4 shows another embodiment, in which two peeling mechanisms 1 are arranged one behind the other. Here, the wire cable 3 is firstly conducted through a first peeling mechanism 1, and in the course thereof is conducted through an opening 5a of a first mandrel 4a of larger cross-section. In the process, an outer part of the outer portion 10 is peeled away and is cut off by first cutting wheels 12a. Part of the outer portion 10 and the inner portion 9 is conducted through the first opening 5a. A second mandrel 4b of a second peeling mechanism 1 is arranged along the pass-through axis D of the first peeling mechanism 1, said second mandrel having a second opening 5b of smaller cross-section. The wire cable 3 is conducted from the first peeling mechanism to the second peeling mechanism, as a result of which these are arranged in series. There, only the inner portion is conducted through the second mandrel 4b, and in the process the remaining outer portion 10 is peeled away and is cut off by second cutting wheels 12b.

A pulling mechanism 16, which is motorized by an electric motor 25, is shown downstream of the second peeling mechanism, with a coiling mechanism 24 which coils up the inner portion being arranged downstream of the pulling mechanism 16. The inner portion 9 is thereby automatically placed in a circular shape in a metal drum.

1. Device for deconstructing wire cables (3) made of a combination of different materials, comprising a peeling mechanism (1) having an opening (5), through which an inner portion (9) of the wire cable (3) runs along a pass-through axis (D) and a pass-through direction (Z), while at least part of an outer portion (10) is cut off, said peeling mechanism (1) having a mandrel (4), through which the opening (5) extends axially, wherein provided next to the mandrel (4) is at least one rotatable cutting wheel (12), which has at least one blade (13) on its circumference and the axis of rotation (R) of which is substantially transverse to the pass-through axis (D), characterized in that a cutting profile (6) of the blade (13) or a joint cutting profile (6) of the blades (13) is of concave shape.

2. Device according to claim 1, characterized in that an individual blade (12) has a concave cutting profile (6).

3. Device according to claim 1, characterized in that the cutting profile (6) is U-shaped or V-shaped.

4. Device according to claim 1, characterized in that at least one blade (13) has a cutting edge with a base portion (17) which is substantially parallel to the axis of rotation (R) of its cutting wheel (12), and in that the cutting edge has at least one side portion (18) which is at an angle to the axis of rotation (R) of its cutting wheel (12).

5. Device according to claim 4, characterized in that at least one side portion (18) is arranged on each side of the base portion (17).

6. Device according to claim 1, characterized in that the cutting profile (6) partially engages around the inner portion (9) during operation of the device.

7. Device according to claim 1, characterized in that the peeling mechanism (1) has a plurality of cutting wheels (12) which are arranged evenly around the pass-through axis (D).

8. Device according to claim 1, characterized in that the blade (13) or the blades (13), during operation of the device, describe a path which passes an outer surface (11) of the mandrel (4) at a small gap (S) therefrom.

9. Device according to claim 8, characterized in that the gap (S) is smaller than 2 mm and preferably is smaller than the diameter of the individual wires of the outer portion (10).

10. Device according to claim 1, characterized in that the mandrel (4) has an outer surface (11) with a frustoconical portion (21) and an adjoining cylindrical portion (22).

11. Device according to claim 1, characterized in that the mandrel (4) has, at least in the transition region from the frustoconical portion (21) to the cylindrical portion (22), an annular element (19) which is preferably made of steel.

12. Device according to claim 1, characterized in that the cutting wheel (12) is arranged at the cylindrical portion (22) and the gap (S) presents itself between the path of the blades (13) and the transition region from the frustoconical portion (21) to the cylindrical portion (22).

13. Device according to claim 1, characterized in that the peeling mechanism (1) has two cutting wheels (12) which are arranged opposite one another around the pass-through axis (D), and in that the cutting profiles (6) substantially encircle a cross-section of the outer surface (11) of the mandrel (4).

14. Device according to claim 1, characterized in that the device has, downstream of the mandrel (4), at least one coiling mechanism for winding up the inner portion (9).

15. Device according to claim 1, characterized in that the device has a pulling mechanism (16) for exerting a pulling force on the wire cable (3), preferably on the inner portion (9) of the wire cable (3) that has passed through the opening of the peeling mechanism (1).

16. Device according to claim 15, characterized in that the pulling mechanism (16) is arranged upstream of the mandrel (4).

17. Device according to claim 15, characterized in that an adjusting mechanism for controlling and adjusting the speed of the pulling mechanism (16) is connected to the pulling mechanism (16).

18. Device according to claim 1, characterized in that the device has at least two peeling mechanisms (1) which are arranged in series one behind the other along the wire cable (3), and in that a first, upstream peeling mechanism (1) has a larger opening (5) than a second, downstream peeling mechanism (5).

19. Method for deconstructing wire cables (3), in which a wire cable (3) is conducted through a peeling mechanism (1) having a mandrel (4), wherein an inner portion (9) is conducted through an opening (5) along a pass-through axis (D) in the mandrel (4) and at least part of an outer portion (10) is peeled away by an outer surface (11) of the mandrel (4), characterized in that an outer portion (10) is cut off via an outer surface (11) of the mandrel (4) by at least one blade (13) of at least one cutting wheel (12) having an axis of rotation (R) transverse to the pass-through axis (D), which blade forms a concave cutting profile (6).

20. Method according to claim 19, characterized in that a plurality of blades (13) form a joint cutting profile (6), which is substantially concave.

21. Method according to claim 19, characterized in that the inner portion (9) is pulled through the mandrel (4) by a pulling mechanism (16) downstream of the mandrel (4).

22. Method according to claim 19, characterized in that the wire cable (3) is moved by a pulling mechanism (16) upstream of the mandrel (4).

23. Method according to claim 22, characterized in that the pulling speed of the pulling mechanism (16) is controllable.

24. Method according to claims 19, characterized in that the cut-off parts of the outer portion (10) are cut to an average length which is smaller than 70 mm and which is preferably smaller than 60 mm.

25. Method according to claims 19, characterized in that the cutting wheel (12) is driven at a rotational speed which is greater than 500 min⁻¹ and which is preferably greater than 550 min⁻¹, particularly preferably around 600 min⁻¹.

26. Method according to claims 19, characterized in that all the cutting wheels (12) in the region of the wire cable (3) rotate in the direction of a pass-through direction (D) of the inner portion (9).

27. Method according to claims 19, characterized in that the inner portion (9) of the wire cable (3) is wound up on a coiling mechanism downstream of the mandrel (4).

28. Method according to claims 19, characterized in that firstly an outer part of the outer portion (10) is peeled away by a first peeling mechanism (1) and then an inner part of the outer portion (10) is peeled away by a second peeling mechanism (1).

29. Method for maintaining or removing a power line, in particular a high-voltage line, wherein a wire cable (3) or part of a wire cable (3) is released from its anchorages, for example anchorages to an overhead line mast, is pulled off, is deconstructed by a method according to claim 19, and the inner portion (9) is rolled up on a coiling mechanism.

30. Method according to claim 29, characterized in that the pulling-off and the method for deconstructing the wire cable (3) or part of the wire cable (3) and rolling it up on the coiling mechanism is carried out in one operation.

31. Method according to claim 29, characterized in that the wire cable (3) or part of the wire cable (3) is made movable from the anchorages of an overhead line mast and is stored in the region of the anchorages, preferably on rolls, and is pulled off.

32. Method according to claims 29, characterized in that a new wire cable is attached to the side of the wire cable (3) or part of the wire cable (3) that is remote from the peeling mechanism (1), before the wire cable is pulled off.
